(19) United States
(12) Patent Application Publication
(10) Pub. No.: US 2017/0192668 A1
(43) Pub. Date: Jul. 6, 2017

(54) PULL-DOWN GESTURE PROCESSING METHOD, DEVICE, AND SYSTEM

(71) Applicant: GUANGZHOU UCWEB COMPUTER TECHNOLOGY CO., LTD., Guangzhou (CN)

(72) Inventors: LIANG RAO, GUANGZHOU (CN); JIANFENG WU, GUANGZHOU (CN)

(21) Appl. No.: 15/389,103

(22) Filed: Dec. 22, 2016

(30) Foreign Application Priority Data
Jan. 6, 2016 (CN) 201610013867.X

(51) Int. Cl. G06F 3/0488

(52) U.S. Cl. CPC G06F 3/04883

(57) ABSTRACT

The present disclosure discloses a pull-down gesture processing method, device and system. The method comprises: refreshing the current display interface in response to that a pull-down distance of a pull-down gesture of a user on a touch display screen is greater than a first set distance and smaller than or equal to a second set distance, wherein the second set distance is greater than the first set distance; and exiting a current display interface in response to that the pull-down distance of the pull-down gesture is greater than the second set distance.

### CROSS REFERENCES TO RELATED APPLICATION

This application is based upon and claims priority to Chinese Patent Application No. 201610013867.X, filed Jan. 6, 2016, the entire contents of which are incorporated herein by reference.

### TECHNICAL FIELD

The present invention relates to the field of mobile Internet technology, and specifically relates to a pull-down gesture processing method, device and equipment.

### BACKGROUND

With continuous development of smart mobile terminal technology, users increasingly like browsing various web contents with mobile terminals, e.g., news, videos, pictures, etc. The mobile terminals generally display various web contents via various browsers.

The relevant browsers display pages of the web contents, e.g., display news information, in a common waterfall flow mode, wherein the contents may be referred to as information flow. Generally, a slide-up or pull-down gesture may be used in a relevant interface of the information flow. The pull-down gesture always bears only one function, e.g., triggering a refresh operation.

However, users often desire to extend the function of the pull-down gesture for executing other operations besides triggering refresh, e.g., returning to a home page, etc.

### SUMMARY

To solve the above technical problems, the present disclosure provides a pull-down gesture processing method, device and equipment for extending the function of a pull-down gesture to execute an exit function besides a refresh function, so that the operation is more natural and smoother.

According to one aspect of the present disclosure, a pull-down gesture processing method includes: refreshing a current display interface in response to that a pull-down distance of a pull-down gesture of a user on a touch display screen is greater than a first set distance and smaller than or equal to a second set distance, wherein the second set distance is greater than the first set distance; and exiting the current display interface in response to that the pull-down distance of the pull-down gesture is greater than the second set distance. The current display interface is a display interface including information flow of multiple channel content sets.

In some embodiments, the refreshing the current display interface in response to that the pull-down distance of a pull-down gesture of a user on a touch display screen is greater than a first set distance and smaller than or equal to a second set distance includes refreshing the current display interface in response to that the pull-down distance of a pull-down gesture of a user on a touch display screen is greater than a first set distance and smaller than or equal to a second set distance and the pull-down gesture is loosened.

In some embodiments, the exiting the current display interface in response to that the pull-down distance of the pull-down gesture is greater than the second set distance includes exiting the current display interface in response to that the pull-down distance of the pull-down gesture is greater than the second set distance and the pull-down gesture is loosened.

According to some embodiments, the current display interface includes an information flow title area that does not follow the pull-down gesture to move and an information flow content area that follows the pull-down gesture to move, and the method further includes: interpolating a progress view display area above the information flow content area in response to the pull-down gesture; displaying a prompt of being about to refresh the current display interface in the progress view display area in response to that the pull-down distance of the pull-down gesture of the user on the touch display screen is greater than the first set distance and smaller than or equal to the second set distance; and displaying a prompt of being about to exit the current display interface in the progress view display area in response to that the pull-down distance of the pull-down gesture is greater than the second set distance. The prompt of being about to refresh the current display interface and/or the prompt of being about to exit the current display interface may include animations.

The exiting the current display interface includes: exiting the current display interface and returning to a home page display interface including the information flow content area and a navigation area.

According to another aspect of the present disclosure, a pull-down gesture processing device includes: a first processing module for refreshing the current display interface in response to that a pull-down distance of a pull-down gesture of a user on a touch display screen is greater than a first set distance and smaller than or equal to a second set distance, wherein the second set distance is greater than the first set distance; and a second processing module for exiting the current display interface in response to that the pull-down distance of the pull-down gesture is greater than the second set distance.

In some embodiments, the first processing module refreshes the current display interface in response to that the pull-down distance of a pull-down gesture of a user on a touch display screen is greater than a first set distance and smaller than or equal to a second set distance and the pull-down gesture is loosened; and the second processing module exits the current display interface in response to that the pull-down distance of the pull-down gesture is greater than the second set distance and the pull-down gesture is loosened.

Optionally, the device further includes a progress view module and a prompt module, the current display interface includes an information flow title area that does not follow the pull-down gesture to move and an information flow content area that follows the pull-down gesture to move. The progress view module is configured to interpolate a progress view display area above the information flow content area in response to the pull-down gesture. The prompt module is configured to display a prompt of being about to refresh the current display interface in the progress view display area in response to that the pull-down distance of the pull-down gesture of the user on the touch display screen is greater than the first set distance and smaller than or equal to the second set distance. The prompt module is further configured to display a prompt of being about to exit the current display interface in the progress view display area in response to that the pull-down distance of the pull-down gesture is greater than the second set distance.

Optionally, the prompt module dynamically displays the prompt of being about to refresh the current display interface and/or the prompt of being about to exit the current display interface by using animations.

According to another aspect of the present disclosure, a pull-down gesture processing system includes a touch display screen, a memory, and a processor operably coupled to the memory and the touch display screen. The memory stores a first set distance and a second set distance, wherein the second set distance is greater than the first set distance. In response to that a pull-down distance of a pull-down gesture on the touch display screen is greater than the first set distance and smaller than or equal to the second set distance, the processor executes an operation of refreshing a current display interface, and in response to that the pull-down distance of the pull-down gesture is greater than the second set distance, the processor executes an operation of exiting the current display interface.

In some embodiments, the processor executes an operation of refreshing a current display interface in response to that a pull-down distance of a pull-down gesture on the touch display screen is greater than the first set distance and smaller than or equal to the second set distance and the pull-down gesture is loosened. The processor executes an operation of exiting the current display interface in response to that the pull-down distance of the pull-down gesture is greater than the second set distance and the pull-down gesture is loosened.

In some embodiments, the current display interface comprises an information flow title area that does not follow the pull-down gesture to move and an information flow content area that follows the pull-down gesture to move. The processor interpolates a progress view display area above the information flow content area in response to the pull-down gesture. In some embodiments, the processor causes the touch display screen to: display a prompt of being about to refresh the current display interface in the progress view display area in response to that the pull-down distance of the pull-down gesture on the touch display screen is greater than the first set distance and smaller than or equal to the second set distance; and display a prompt of being about to exit the current display interface in the progress view display area in response to that the pull-down distance of the pull-down gesture is greater than the second set distance.

As seen in the embodiments of the present disclosure, operations executed under different conditions are predefined, the current display interface is refreshed under the condition that the pull-down distance of the pull-down gesture is greater than the first set distance and smaller than or equal to the second set distance, and the current display interface is exited under the condition that the pull-down distance of the pull-down gesture is greater than the second set distance, so that the function of the pull-down gesture is extended to execute the exit function besides the refresh function; and such a “pull-down gesture return mode” can be paired with a mode of “entering a channel page via a slide-up gesture”, and can be considered as a reverse operation of entry, so the present disclosure better conforms to the logical thinking of operation experience of users and the operation is more natural and smoother.

Further, according to some embodiments of the present disclosure, the current display interface is refreshed under the condition that the pull-down distance of the pull-down gesture is greater than the first set distance and smaller than or equal to the second set distance and the pull-down gesture is loosened; and the current display interface is exited under the condition that the pull-down distance of the pull-down gesture is greater than the second set distance and the pull-down gesture is loosened.

In some embodiments of the present disclosure, a prompt of the current progress state can be displayed via a progress view display area according to the moving distance of the displayed content or the sliding distance of the pull-down gesture, so that the user understands the operation corresponding to the current gesture more easily.

### BRIEF DESCRIPTION OF THE DRAWINGS

The exemplary implementations of the present disclosure will be described in more detail in combination with the accompanying drawings, so that the above-mentioned and other purposes, features and advantages of the present disclosure will become more obvious, wherein the same reference signs generally indicate the same components in the exemplary implementations of the present disclosure.

FIG. 1 is a schematic flow diagram of a pull-down gesture processing method according to one embodiment of the present disclosure;

FIG. 2 is another schematic flow diagram of the pull-down gesture processing method according to one embodiment of the present disclosure;

FIG. 3 is a structural schematic diagram of a display interface according to one embodiment of the present disclosure;

FIG. 4 is a schematic diagram of a sliding distance of a pull-down gesture according to one embodiment of the present disclosure;

FIG. 5 is a schematic block diagram of a pull-down gesture processing device of the present disclosure;

FIG. 6 is another schematic block diagram of the pull-down gesture processing device of the present disclosure;

FIG. 7 is a schematic block diagram of processing equipment of the present disclosure.

### DETAILED DESCRIPTION OF THE EMBODIMENTS

Preferred implementations of the present disclosure will be described in more detail below with reference to the accompanying drawings. Although the preferred implementations of the present disclosure are shown in the accompanying drawings, it should be understood that the present disclosure may be realized in various forms and should not be limited to the implementations illustrated herein. Conversely, these implementations are provided to make the present disclosure more thorough and complete, and completely transmit the scope of the present disclosure to those skilled in the art.

The embodiments of the present disclosure provide a pull-down gesture processing method, which can extend the function of a pull-down gesture and realize the functions of exiting the current display interface and returning to the home page by pull-down besides pull-down refresh.

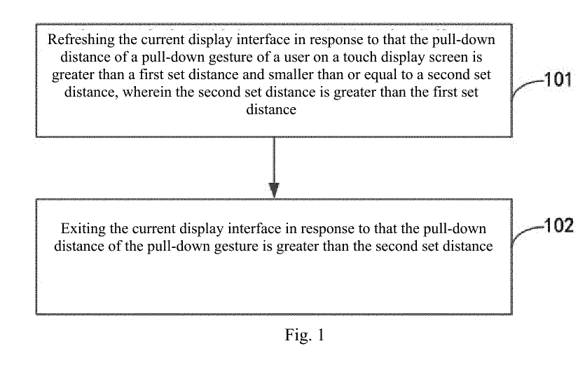

FIG. 1 is a schematic flow diagram of a pull-down gesture processing method according to one embodiment of the present disclosure.

As show in FIG. 1, step 101 includes: refreshing a current display interface in response to that a pull-down distance of a pull-down gesture of a user on a touch display screen is greater than a first set distance and smaller than or equal to a second set distance. The second set distance is greater than the first set distance.

The current display interface is a display interface including information flow of multiple channel content sets. This step may also include: refreshing the current display interface in response to that the pull-down distance of a pull-down gesture of a user on a touch display screen is greater than a first set distance and smaller than or equal to a second set distance and the pull-down gesture is loosened (e.g., the hand is lifted from the touch display screen).

The pull-down distance of the pull-down gesture may be, for example, a distance of downward sliding of a gesture, or a distance of downward moving of at least part of display contents in the current display interface along with the gesture, etc.

Step 102 includes: exiting the current display interface in response to that the pull-down distance of the pull-down gesture is greater than the second set distance. This step may include: exiting the current display interface in response to that the pull-down distance of the pull-down gesture is greater than the second set distance and the pull-down gesture is loosened.

In some embodiments of the present disclosure, operations executed under different conditions are predefined, the current display interface is refreshed under the condition that the pull-down distance of the pull-down gesture is greater than the first set distance and smaller than or equal to the second set distance, and the current display interface is exited under the condition that the pull-down distance of the pull-down gesture is greater than the second set distance, so that the function of the pull-down gesture is extended to execute the exit function besides the refresh function; and such a “pull-down gesture return mode” can be paired with a mode of “entering a channel page via a slide-up gesture”, and can be considered as a reverse operation of entry, so the method better complies with the logical thinking of operation experience of users and the operation is more natural and smoother.

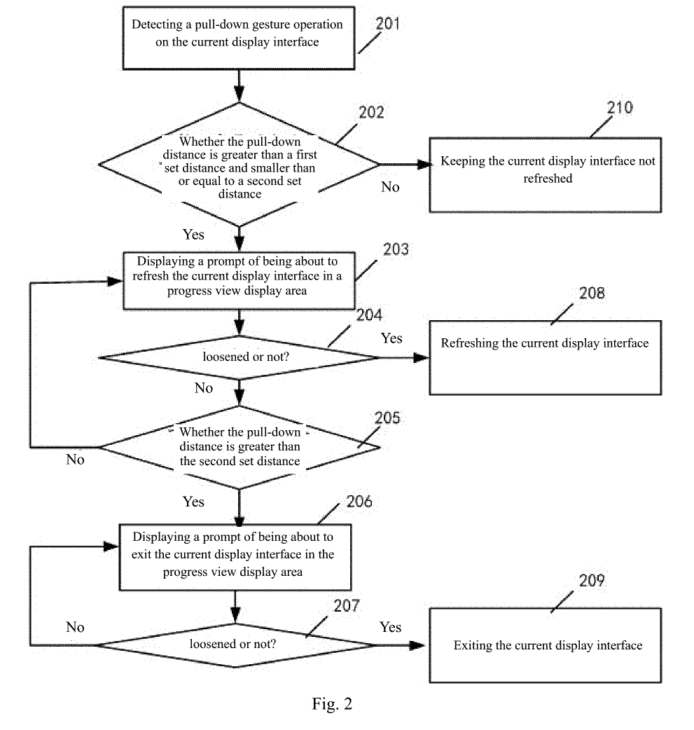

FIG. 2 is another schematic flow diagram of the pull-down gesture processing method according to one embodiment of the present disclosure.

As shown in FIG. 2, step 201 includes: detecting a pull-down gesture operation on the current display interface.

The current display interface is a display interface including information flow of multiple channel content sets.

Step 202 includes: determining whether the pull-down distance of the pull-down gesture is greater than a first set distance and smaller than or equal to a second set distance; if so, carrying out step 203; otherwise, carrying out step 210.

In some embodiments of the present disclosure, different operations triggered to be executed by the pull-down distance of the pull-down gesture may be predefined. For example, when the pull-down distance of the pull-down gesture is greater than the first set distance and smaller than or equal to the second set distance, it expresses executing a refresh function; when the pull-down distance of the pull-down gesture is smaller than the first set distance, it expresses not executing the refresh function; and when the pull-down distance of the pull-down gesture is greater than the second set distance, it expresses exiting the current display interface and returning to the home page, wherein the second set distance is greater than the first set distance. The pull-down distance of the pull-down gesture, for example, may be a distance of downward sliding of a gesture, or a distance of downward moving of at least part of display contents in the current display interface along with the gesture.

Step 203 includes: displaying a prompt of being about to refresh the current display interface in a progress view display area; and carrying out step 204.

In the embodiment of the present disclosure, the current display interface includes an information flow title area not following the pull-down gesture to move and an information flow content area following the pull-down gesture to move. The information flow content area may include a system list control area and a progress view display area; and in the case where the pull-down gesture slides, the system list control area is pulled down along with the pull-down gesture, and the progress view display area displays the current progress state according to the pull-down distance of the pull-down gesture.

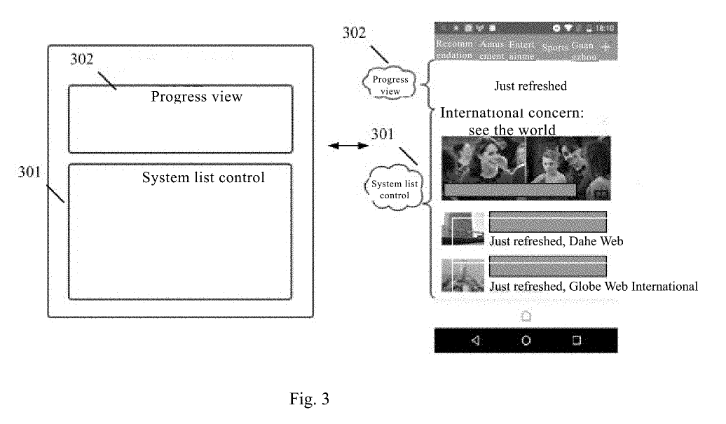

FIG. 3 is a structural schematic diagram of a display interface according to one embodiment of the present disclosure. As shown in FIG. 3, the current display interface in the embodiment of the present disclosure includes a system list control area 301 and a progress view display area 302. The system list control can move the whole list of contents down during continuous pull-down, and a pull-down progress animation appears in the progress view display area 302 at the top of the list.

For example, in the case where the pull-down distance of the pull-down gesture is greater than the first set distance and smaller than or equal to the second set distance, the progress view display area 302 displays a prompt of being about to refresh the current display interface dynamically by adopting an animation.

Step 204 includes: determining whether the pull-down gesture is loosened; if so, carrying out step 208; otherwise, carrying out step 205.

Step 205 includes: determining whether the pull-down distance of the pull-down gesture is greater than the second set distance; if so, carrying out step 206; otherwise, returning to step 203.

Step 206 includes: displaying a prompt of being about to exit the current display interface in the progress view display area; and carrying out step 207.

For example, in the case where the pull-down distance of the pull-down gesture is greater than the second set distance, the progress view display area displays a prompt of being about to exit the current display interface dynamically by adopting an animation.

Step 207 includes: determining whether the pull-down gesture is loosened; if so, carrying out step 209; otherwise, returning to step 206.

Step 208 includes: refreshing the current display interface.

Step 209 includes: exiting the current display interface.

Exiting the current display interface includes: exiting the current display interface and returning to a home page display interface including an information flow content area and a navigation area.

Step 210 includes: keeping the current display interface not refreshed.

In this step, the pull-down distance of the pull-down gesture is smaller than the first set distance, so the current display interface is kept not refreshed.

Taking the operation on a browser display interface as an example, on the current display interface, namely on a channel page of information flow, normal (short-distance) pull-down is the refresh function, and normal use of the refresh function is controlled via normal pull-down length. In long-distance pull-down, a ball icon of the progress view display area may change the color, for example, the blue ball may be changed into a red ball, showing the function of exiting the current display interface and returning to the home page. After the pull-down gesture is detected to be loosened, the home page may be revealed between the title bar and the information flow content by adopting a reverse animation of entering the channel page, thus, the long-distance pull-down in the embodiment of the present disclosure is a reverse operation of entering the channel page, achieves a reverse effect of entering the channel page and conforms to common use cognition and logic, and the user experience can be improved. It should be noted that the above solution is applicable to each channel page of the information flow.

Specifically, taking a relevant browser as an example, the pull-down gesture of headline information of the browser simultaneously bears a function of exiting the current display interface and returning to the home page, a function of refreshing via common strength short-distance pull-down and a function of returning to the home page via long-distance pull-down in the solution. Such a “pull-down gesture return mode” can be paired with a mode of “entering a channel page via a slide-up gesture”, and can be considered as a reverse operation of entry, so the method better conforms to the logical thinking of operation experience of users and the operation is more natural and smoother.

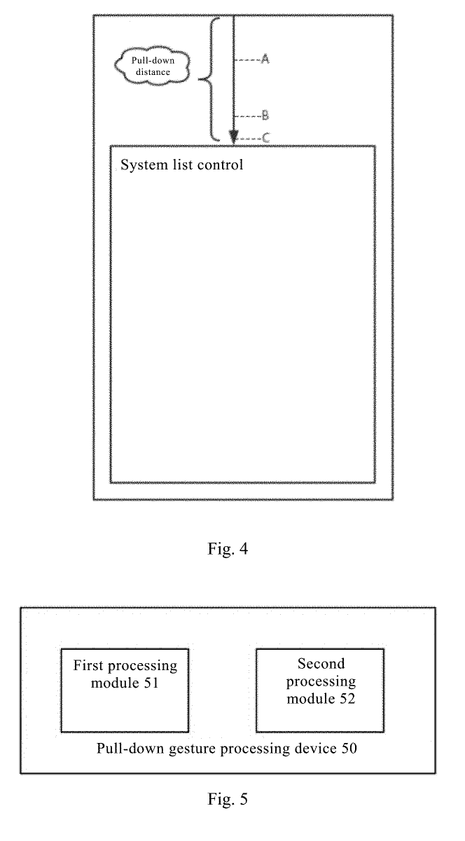

FIG. 4 shows a schematic diagram of a sliding distance of a pull-down gesture according to one embodiment of the present disclosure.

In the embodiment of the present disclosure, determination to fresh or exit the current display interface by determining the pull-down distance is taken as an example. The pull-down distance may be a distance of downward moving of display contents or a distance of downward sliding of a pull-down gesture or the like. The embodiment of the present disclosure may realize three-section pull-down, including:

1) When it is pulled down to the section above point A and then loosened, the pull-down distance at the moment is smaller than the first set distance, automatic rebound is performed, no operation is executed, and refresh is not executed.

2) When it is pulled down to the section between point A and point B (including point A but not including point B) and then loosened, the pull-down distance at the moment is greater than the first set distance and smaller than or equal to the second set distance, a refresh operation is executed.

3) When it is pulled down to the section between point B and point C (including point B and point C) and then loosened, the pull-down distance at the moment is greater than the second set distance, an operation of exiting the current display interface is executed.

In the embodiments of the present disclosure, the current display interface is refreshed under the condition that the pull-down distance of the pull-down gesture is greater than the first set distance and smaller than or equal to the second set distance, and the current display interface is exited under the condition that the pull-down distance of the pull-down gesture is greater than the second set distance, so that unmatched experience of entering a channel by slide-up but refreshing rather than exiting during pull-down is solved. In the embodiment of the present disclosure, one gesture bears two functions, that is, pull-down can bear the functions of refresh and exit, moreover, the method conforms to the use scenario, front and back operation logics are matched, and the method does not need additional learning and memory of users and is thus more suitable for the users.

The pull-down gesture processing method of the present disclosure is described in detail above, and correspondingly, the present disclosure further provides a pull-down gesture processing device and equipment.

FIG. 5 is a schematic block diagram of a pull-down gesture processing device of the present disclosure.

As shown in FIG. 5, the pull-down gesture processing device 50 includes a first processing module 51 and a second processing module 52.

The first processing module 51 is used for refreshing the current display interface in response to that the pull-down distance of a pull-down gesture of a user on a touch display screen is greater than a first set distance and smaller than or equal to a second set distance, wherein the second set distance is greater than the first set distance.

The current display interface is a display interface including information flow of multiple channel content sets. The pull-down distance of the pull-down gesture may have different definitions according to needs, e.g., a distance of downward sliding of a gesture, or a distance of downward moving of at least part of display contents in the current display interface along with the gesture, etc.

The second processing module 52 is used for exiting the current display interface in response to that the pull-down distance of the pull-down gesture is greater than the second set distance.

Hence, in the technical solution of the embodiment of the present disclosure, operations executed under different conditions are predefined, the current display interface is refreshed under the condition that the pull-down distance of the pull-down gesture is greater than the first set distance and smaller than or equal to the second set distance, and the current display interface is exited under the condition that the pull-down distance of the pull-down gesture is greater than the second set distance, so that the function of the pull-down gesture is extended to execute an exit function besides a refresh function; and such a “pull-down gesture return mode” can be paired with a mode of “entering a channel page via a slide-up gesture”, and can be considered as a reverse operation of entry, so the device better conforms to the logical thinking of operation experience of users and the operation is more natural and smoother.

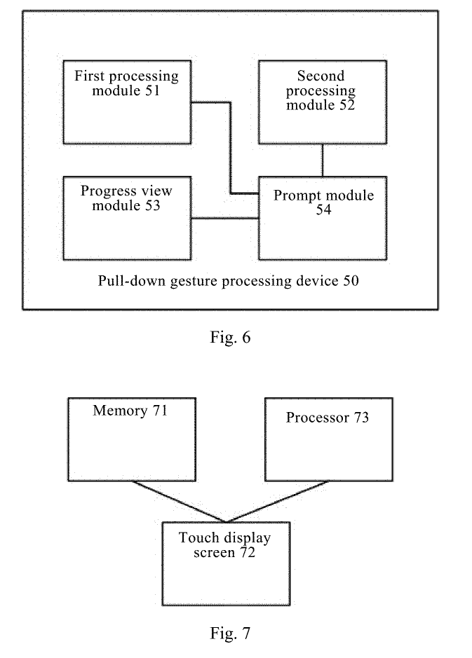

FIG. 6 is another schematic block diagram of the pull-down gesture processing device of the present disclosure.

As shown in FIG. 6, besides the first processing module 51 and the second processing module 52, the pull-down gesture processing device further includes other functional modules, e.g., a progress view module 53 and a prompt module 54.

The first processing module 51 is used for refreshing the current display interface in response to that the pull-down distance of a pull-down gesture of a user on a touch display screen is greater than a first set distance and smaller than or equal to a second set distance and the pull-down gesture is loosened.

The second processing module 52 is used for exiting the current display interface in response to that the pull-down distance of the pull-down gesture is greater than the second set distance and the pull-down gesture is loosened.

The current display interface is a display interface including information flow of multiple channel content sets. The pull-down distance of the pull-down gesture, for example, may be a distance of downward sliding of a gesture, or a distance of downward moving of at least part of display contents in the current display interface along with the gesture, etc.

Exiting the current display interface may include: exiting the current display interface and returning to a home page display interface including an information flow content area and a navigation area.

The device further includes the progress view module 53 and the prompt module 54, the current display interface includes an information flow title area that does not follow the pull-down gesture to move and an information flow content area that follows the pull-down gesture to move. The progress view module 53 is used for interpolating a progress view display area above the information flow content area in response to the pull-down gesture. The prompt module 54 is used for displaying a prompt of being about to refresh the current display interface in the progress view display area in response to that the pull-down distance of the pull-down gesture of a user on a touch display screen is greater than a first set distance and smaller than or equal to a second set distance; or displaying a prompt of being about to exit the current display interface in the progress view display area in response to that the pull-down distance of the pull-down gesture is greater than the second set distance. The prompt module 54 dynamically displays the prompt of being about to refresh the current display interface and/or the prompt of being about to exit the current display interface by adopting animations.

FIG. 7 is a schematic block diagram of processing equipment of the present disclosure.

As shown in FIG. 7, the processing equipment includes a memory 71, a touch display screen 72 and a processor 73.

The memory 71 stores a first set distance and a second set distance, wherein the second set distance is greater than the first set distance. In response to that the pull-down distance of a pull-down gesture of a user on the touch display screen 72 is greater than the first set distance and smaller than or equal to the second set distance, the processor 73 executes an operation of refreshing the current display interface, and in response to that the pull-down distance of the pull-down gesture is greater than the second set distance, the processor 73 executes an operation of exiting the current display interface.

According to the technical solution of the embodiment of the present disclosure, the current display interface is refreshed under the condition that the pull-down distance of the pull-down gesture is greater than the first set distance and smaller than or equal to the second set distance and the pull-down gesture is loosened, and the current display interface is exited under the condition that the pull-down distance of the pull-down gesture is greater than the second set distance and the pull-down gesture is loosened, so that unmatched experience of entering a channel by slide-up but refreshing rather than exiting during pull-down except refresh is solved. In the embodiment of the present disclosure, one gesture bears two functions, that is, pull-down can bear the functions of refresh and exit, moreover, the processing equipment conforms to the use scenario, front and back operation logics are matched, and the processing equipment does not need additional learning and memory costs of users and is thus more suitable for the users.

The technical solutions of the present disclosure are described in detail above with reference to the accompanying drawings.

Moreover, the method according to the present disclosure may also be realized as a computer program, and the computer program includes computer program code instructions for executing the steps defined in the above method of the present disclosure. The method according to the present disclosure may also be realized as a computer program product. The computer program product includes a non-transitory computer-readable medium, and a computer program, when executed by a processor, executing the above functions defined in the above method of the present disclosure is stored in the computer-readable medium. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. It should be appreciated by those skilled in the art that various exemplary logic blocks, modules, circuits and algorithmic steps described in combination with the disclosure herein may be realized as electronic hardware, computer software or a combination of the both.

The flow diagrams and the block diagrams in the accompanying drawings show system architectures, functions and operations which may be realized according to the systems and the methods of multiple embodiments of the present disclosure. In this regard, each block in the flow diagrams or the block diagrams may represent a part of a module, a program segment or a code, and the part of the module, the program segment or the code includes one or more executable instructions for realizing specified logical functions. It should also be noted that in some alternative implementations, the functions labeled in the blocks may also occur in sequence different from that in the accompanying drawings. For example, two continuous blocks may actually be executed in parallel substantially or executed in opposite sequence sometimes, which depends on the involved functions. It should also be noted that each block in the block diagrams and/or flow diagrams and a combination of the blocks in the block diagrams and/or flow diagrams may be realized by a dedicated hardware-based system for executing specified functions or operations, or realized by a combination of dedicated hardware and computer instructions.

The embodiments of the present disclosure have been described above, and the above descriptions are exemplary but not exhaustive and are not limited to the disclosed embodiments. Many modifications and alterations made without departing from the scope and spirit of the described embodiments are obvious for those of ordinary skill in the art. The terms in the descriptions are selected to best interpret the principle of each embodiment, practical application or improvement on technologies in the market, or to make other persons of ordinary skill in the art understand the embodiments disclosed in the descriptions.

What is claimed is:

1. A pull-down gesture processing method, comprising:
refreshing a current display interface in response to that a pull-down distance of a pull-down gesture on a touch display screen is greater than a first set distance and smaller than or equal to a second set distance, wherein the second set distance is greater than the first set distance; and
exiting the current display interface in response to that the pull-down distance of the pull-down gesture is greater than the second set distance.

2. The method of claim 1, wherein the current display interface is a display interface comprising information flow of multiple channel content sets.

3. The method of claim 1, wherein:
the refreshing the current display interface in response to that the pull-down distance of a pull-down gesture on a touch display screen is greater than a first set distance and smaller than or equal to a second set distance comprises:
refreshing the current display interface in response to that the pull-down distance of a pull-down gesture on a touch display screen is greater than a first set distance and smaller than or equal to a second set distance and the pull-down gesture is loosened;
the exiting the current display interface in response to that the pull-down distance of the pull-down gesture is greater than the second set distance comprises:
exiting the current display interface in response to that the pull-down distance of the pull-down gesture is greater than the second set distance and the pull-down gesture is loosened.

4. The method of claim 3, wherein:
the current display interface comprises an information flow title area that does not follow the pull-down gesture to move and an information flow content area that follows the pull-down gesture to move, and
the method further comprises:
interpolating a progress view display area above the information flow content area in response to the pull-down gesture;
displaying a prompt of being about to refresh the current display interface in the progress view display area in response to that the pull-down distance of the pull-down gesture on the touch display screen is greater than the first set distance and smaller than or equal to the second set distance; and
displaying a prompt of being about to exit the current display interface in the progress view display area in response to that the pull-down distance of the pull-down gesture is greater than the second set distance.

5. The method of claim 4, wherein the prompt includes an animation.

6. The method of claim 4, wherein the exiting the current display interface comprises: exiting the current display interface and returning to a home page display interface.

7. A pull-down gesture processing device, comprising:
a first processing module for refreshing a current display interface in response to that a pull-down distance of a pull-down gesture on a touch display screen is greater than a first set distance and smaller than or equal to a second set distance, wherein the second set distance is greater than the first set distance; and
a second processing module for exiting the current display interface in response to that the pull-down distance of the pull-down gesture is greater than the second set distance.

8. The device of claim 7, wherein:
the first processing module refreshes the current display interface in response to that the pull-down distance of a pull-down gesture on a touch display screen is greater than a first set distance and smaller than or equal to a second set distance and the pull-down gesture is loosened; and
the second processing module exits the current display interface in response to that the pull-down distance of the pull-down gesture is greater than the second set distance and the pull-down gesture is loosened.

9. The device of claim 7, wherein the device further comprises a progress view module and a prompt module, the current display interface comprises an information flow title area that does not follow the pull-down gesture to move and an information that flows content area following the pull-down gesture to move,
the progress view module is configured to interpolate a progress view display area above the information flow content area in response to the pull-down gesture; and
the prompt module is configured to display a prompt of being about to refresh the current display interface in the progress view display area in response to that the pull-down distance of the pull-down gesture of the user on the touch display screen is greater than the first set distance and smaller than or equal to the second set distance;
or displaying a prompt of being about to exit the current display interface in the progress view display area in response to that the pull-down distance of the pull-down gesture is greater than the second set distance.

10. The device of claim 9, wherein the prompt module dynamically displays the prompt of being about to refresh the current display interface and/or the prompt of being about to exit the current display interface by using animations.

11. A pull-down gesture processing system, comprising:
a touch display screen;
a memory; and
a processor operably coupled to the memory and the touch display screen,
wherein:
the memory stores a first set distance and a second set distance, wherein the second set distance is greater than the first set distance,
in response to that a pull-down distance of a pull-down gesture on the touch display screen is greater than the first set distance and smaller than or equal to the second set distance, the processor executes an operation of refreshing a current display interface, and
in response to that the pull-down distance of the pull-down gesture is greater than the second set distance, the processor executes an operation of exiting the current display interface.

12. The system of claim 11, wherein:
the processor executes an operation of refreshing a current display interface in response to that a pull-down distance of a pull-down gesture on the touch display screen is greater than the first set distance and smaller than or equal to the second set distance and the pull-down gesture is loosened, and
the processor executes an operation of exiting the current display interface in response to that the pull-down distance of the pull-down gesture is greater than the second set distance and the pull-down gesture is loosened.

13. The system of claim 11, wherein the current display interface comprises an information flow title area that does not follow the pull-down gesture to move and an information flow content area that follows the pull-down gesture to move.

14. The system of claim 11, wherein the processor interpolates a progress view display area above the information flow content area in response to the pull-down gesture.

15. The system of claim 14, wherein the processor causes the touch display screen to:
display a prompt of being about to refresh the current display interface in the progress view display area in response to that the pull-down distance of the pull-down gesture on the touch display screen is greater than the first set distance and smaller than or equal to the second set distance; and
display a prompt of being about to exit the current display interface in the progress view display area in response to that the pull-down distance of the pull-down gesture is greater than the second set distance.
